(19) United States
(12) Patent Application Publication
(10) Pub. No.: US 2026/0243022 A1
(43) Pub. Date: Aug. 20, 2026

(54) CORRUGATED CARDBOARD AND A METHOD FOR PRODUCING A CORRUGATED CARDBOARD

(71) Applicant: JML INNOVATION AB, Lund (SE)

(72) Inventors: Mi ÅBERG, Lund (SE); Lars PALM, Åkarp (SE); Lars BERGHOLTZ, Höganäs (SE)

(73) Assignee: JML INNOVATION AB, Lund (SE)

(21) Appl. No.: 19/161,622

(22) PCT Filed: Mar. 1, 2024
(86) PCT No.: PCT/SE2024/050199

§ 371 Date: Sep. 2, 2025

(30) Foreign Application Priority Data
Mar. 3, 2023 (SE) 2330112-0

(51) Int. Cl. D21H 27/00; B31F 5/04; D21F 11/12

(52) U.S. Cl. CPC D21H 1/00; B31F 5/04; D21F 11/12

(57) ABSTRACT

A corrugated cardboard (1) comprising a first and second flat pretreated linerboard (2, 3) with therebetween an arranged corrugated flute (4) having an internal flute material (6) and an A- and B-surface (5a, 5b). The corrugated flute (4) comprises peaks (7a, 7B) and valleys (8a, 8b) arranged opposite each other. The linerboards (2, 3) comprises an inner surface (9a, 9b) and an opposite outer surface (10a, 10b). The inner surfaces (9a, 9b) welds against the peaks (7a, 7b) with an adhesive being a polymeric coating (11a, 11b) which the inner surfaces (9a, 9b) are pretreated with. The peaks (7a, 7b) comprises bending zones (12a, 12b) with surface openings (13) which the polymeric coatings (11a, 11b) adheres around as well as against the internal flute material (6) exposed in the surface openings (13).

### FIELD OF THE INVENTION

The present invention relates to a corrugated cardboard and a method for producing a corrugated cardboard.

### BACKGROUND OF THE INVENTION

Corrugated cardboard is a type of packaging material principally comprising a corrugated flute and one or two flat linerboards. The corrugated flute and the flat linerboards are attached to each other with an adhesive applied between the corrugated flute and the linerboards. Corrugated cardboard is commonly used in the making of boxes in different sizes, shapes and styles.

Corrugated cardboard is made in a wet processes where the flute, to be corrugated during the process, and the linerboards have arrived to a manufacturing site for the manufacture of the corrugated cardboard. Common is that the material for making of corrugated carboard enters into large and complex machines. A common manufacturing process is the use of steam and a starch dispersion, manufactured on site, which means adding a lot of moisture for forming and attaching the corrugated flute and the linerboards to each other and later use large dryers to exsiccate the increased moisture content generated in the assembly process. In such and other similar known manufacture processes, it is common the corrugated cardboard after manufacture needs to undergo a curing process. The curing process is a time consuming process and it can take several hours for the corrugated cardboard to be ready for further handling, for example printing, crease and cut. The known drawbacks with the present processes are not only that the manufacturing process is time consuming, but also that the manufacturing process, including subsequent curing, demands a lot of space during production the corrugated cardboard. Further are these drawbacks also costly due to high energy consumption in the manufacturing process.

Other attaching methods are to attach the corrugated flute to the flat linerboards with a polymer. A problem with current and such attaching methods is that it is difficult to minimize the amount of glue and at the same time not affect the strength negatively. Therefore, common is that when utilizing polymer for attaching, the minimizing step is avoided because it leads to week structure in the corrugated cardboard. A further problem which arises with existing technique when using polymer with current high level to uphold the strength in the construction is that the recycling processes and machines because of the high level of polymer in the waste demands a lot of service and maintenance of the machines.

### SUMMARY OF THE INVENTION

An object of the present invention is to provide a corrugated cardboard which overcomes the above mentioned problems.

In relation to mentioned object, a further object of the invention is to provide a method for producing a corrugated cardboard, where both the method and the corrugated cardboard are improvements compared to those of the prior art.

The objectives with the current invention are achieved by that the invention relates to a corrugated cardboard comprising a first flat linerboard, a second flat linerboard, a corrugated flute being arranged between the first and the second flat linerboard. The corrugated flute comprises an A-surface, a B-surface, and an internal flute material being arranged between the A- and B-surface. The corrugated flute comprises A-peaks and A-valleys which are arranged opposite each other. Further, the corrugated flute comprises B-peaks and B-valleys which are arranged opposite each other. The first flat linerboard comprises a first inner surface and an opposite arranged first outer surface. The second flat linerboard comprises a second inner surface and an opposite arranged second outer surface. The first inner surface is connected against the A-peaks with a first re-active adhesive. The second inner surface is connected against the B-peaks with a second re-activated adhesive. The referred adhesive may be starch free. An adhesive comprising starch comprising water or moisture is not suitable for the invention and such starch is not an aim for use in regards of the presented embodiments in this text. Starch adhesives comprising a polymer are in this text referred to as polymeric coatings which are a material which is used in the presented embodiments to connect mention flat linerboards with the corrugated flute. Further, the first inner surface is pre-treated with the first re-activated adhesive being a first polymeric coating, the second inner surface is pre-treated with the second re-activated adhesive being a second polymeric coating. The A-peaks comprises a first A-bending zone and the B-peaks comprises a first B-bending zone. The A- and B-bending zones comprises fibre dislocations in the internal flute material. The fibre dislocations may be surface openings. A surface opening may be a surface crack, surface slit or surface scratch. In the connection between the A- and B-peaks and the first and second inner surfaces the polymeric coatings are adhered to the surface including the openings and against the internal flute material in the surface openings. The corrugated flute comprises more fibre dislocations in its flute material in areas which are bending zones compared to parts of the corrugated flute which are arranged between bending zones. An effect of the invention is that the surface openings increase the contact surface between the peaks and the inner surfaces whereby the polymeric coating may be reduced, optimized, while strength may be improved compared to prior art. Corrugated flute originates from a base material which is processed to obtain a wave or corrugated form. Common is that the base material is introduced into the machine, equipment, for producing the corrugated cardboard also in that same machine is created into a corrugated flute comprising A-and B-peaks.

According to one embodiment, the adhesive being polymeric coating is heat re-activated. An effect of this is that the process therefore may be moisture free, no moisture or water is added, during the manufacture of the corrugated cardboard.

No moisture has been added to the pretreated linerboards, nor before entering into the cardboard manufacturing process, nor during the cardboard manufacturing process. Moisture level in the pretreated linerboards and the corrugated flute are not to exceed 15%, and preferably not 10%. At a moisture level exceeding 15%, the adhesive connection between the linerboards and the corrugated flute material is negatively affected because the process would utilize its heat energy for removing the moisture from the material rather than using the heat energy for adhering the polymeric coating so that the pretreated linerboards and corrugated flute material will attach and adhere to each other. A further problem when a moisture level exceeding 15% is that surface of linerboards, outer surface, will not be smooth and even. Such a surface will be corrugated as an effect of the moisture affecting the material of the linerboards. Such unsmooth and uneven surface is difficult to print and write on. To make unsmooth and uneven surfaces smooth and flat, the cardboard would after manufacturing process need to undergo an extra process to make the surface flat and smooth which will be time consuming and affect cost negatively.

According to one embodiment, the internal flute material comprises fibres which in the surface openings extend with a fibre end out and away from an internal surface in the surface openings. An effect of this is that the fibre ends in the surface openings together with the surface area in the surface opening increases the total surface area.

The surface openings are created in the peaks of the corrugated flute material and during the manufacturing process when the flute material is shaped into a corrugated flute material by a corrugating wheel in the manufacturing process. Because of the low moisture level in the flute material, which is not to exceed 15% and preferably not to exceed 10%, the surface openings are created as cracks by the corrugated wheel during the forming of the peeks. If the flute material would have had a moisture level exceeding 15%, the flute material would risk being too flexible and soft in its material properties, and only be shaped with peeks without presence of any, or very few or too small, cracks or surface openings when the peeks would be formed by the corrugated wheel. If the cracks or surface openings are too small, the internal fibres will not be exposed.

According to one embodiment, the fibre ends extending away from the internal surface are merged with the polymer coatings to a fibre reinforced connection between the peaks and the inner surfaces. An effect of this is that this will create a strong and durable connection between the peaks and the inner surfaces.

According to one embodiment, the polymeric coatings on the respective inner surfaces have a thickness of 1-10 μm. This has the effect that the layer of polymeric coating applied can be optimized. To facilitate recycling of the corrugated cardboard an aim is to have the thickness of the polymeric coating as thin as possible. During recycling process, cardboard is mixed with a liquid to a slurry. In the process of the slurry, the polymeric coatings is released and separated from the used cardboard. After some time, the equipment used in the recycling process needs to be cleaned from the separated polymeric coating. Therefore, the less polymeric coating a corrugated cardboard comprises, the more corrugated cardboard can be recycled before the recycling process needs to be stopped for maintenance, cleaning and emptying of the separated polymeric coatings.

According to one embodiment, the polymeric coatings on the respective inner surfaces of the liners have a surface weight being 0.5-10 g/m² (GSM). This has the effect that the polymeric coating may relate to a capillary surface tension and diffusion processes resulting in that the polymeric coating in a liquid state will be drawn or sucked into the two adjacent surfaces of the inner surface and the peak facing each other in the connecting phase.

According to one embodiment, the inner surfaces comprise a fibre structure which the polymeric coating is bonded to in a preceding process. The flat linerboards with the inner surfaces have been pre-treated with the polymeric coatings in order to achieve adhesion to the respective inner surfaces.

According to one embodiment, the polymeric coating, being coated against the inner surfaces, allows for diffusion through the polymeric coating. An effect of this is that the amount of polymeric coating used for coating of surface can be reduced when the coating is applied in such a way that diffusion is enabled.

According to one embodiment, the inner surfaces are pre-treated with the polymeric coating and the outer surfaces are coating free. An effect of this is that facilitates printing or other treatment of the surfaces. In this text, that surfaces are coating free means that the surfaces don't comprise any polymeric coating which actively has been applied against the surfaces. Further, in this text the word coating refers to a polymeric coating aimed to be able to be change from solid phase to liquid phase or reactivated phase to be tacky and thus able to weld to the corrugated flute and thereafter return to the solid state due to heat loss.

The polymeric coating may comprise PVA or PVA-C which is a polyvinyl acetate component. The advantage of PVA or PVA-C is that these components can be reactivated upon exposure of heat and pressure, i.e. welding. The pretreated linerboards are pretreated with the polymeric coating comprising PVA or PVA-C before delivery to the corrugated cardboard production. In the cardboard manufacture process, heat in the process reactivates the polymeric coating comprising PVA or PVA-C whereby the coating adheres and welds against the corrugated flute whereby the linerboard is connected to the corrugated flute material.

According to one embodiment, at connection between the peaks and the inner surfaces, first and second bellows are formed on each side of the peaks. In a further embodiment, the first bellows arranged on each side of the A-peaks are larger compared to the second bellows arranged on each side of the B-peaks. An effect of this that the surface aimed for being used for graphic illustrations, for example to be printed with a text or picture, will be flatter and smoother and therefore more suitable for text and pictures.

According to one embodiment, on the pre-treated inner surfaces, the first polymeric coating comprises a first coating surface which has a smoother surface compared to a second coating surface which is arranged on the second polymeric coating. The difference in surface of smoothness is a result from how heat is applied against the first and second linerboards during the manufacture process of the corrugated cardboard. The first flat linerboard is affected by a first heat that may have a direction against the outer surface and through the first flat linerboard. The second flat linerboard is affected by a second heat having a direction towards the inner surface of the second flat linerboard. The heating enables direct positioning of the corrugated flute against the respective inner surfaces. A further effect of this is that waste from the manufacture process is reduced compared to existing technologies and that there is no curing needed after the performed assembly process.

According to one embodiment, the A-peaks comprises a second A-bending zone and that a first extension part is arranged between the first and the second A-bending zone, and, the B-peaks comprises a second B-bending zone a that a second extension part is arranged between the first and second B-bending zone. An effect of the added second A- and B-bending zones and the mention extension parts is that the surface area between the corrugated flute and the inner surfaces can be regulated and adjusted to the needs. For example, a corrugated cardboard aimed to be used in an environment demanding high rigidity, the added second bending zones and the extension parts being connected against the inner surfaces will then increase the rigidity of the corrugated cardboard.

According to one embodiment, the first extension part between the first and the second A-bending zone comprises a third A-bending zone, and the second extension part between the first and second B-bending zone comprises a third B-bending zone. According to one further embodiment, the first and the second extension parts are V-shaped. In a further embodiment, the extension part being V-shaped is adapted to resiliently move towards and away from the inner surface with at least one of the first or second bending zones not attached to the inner surface. An effect of this is that the V-shape allows resilient movements between the first and second flat linerboard. An effect of the resilience, or flexibility, of the corrugated cardboard is that it provides the possibility to take up dynamic forces against the surfaces on the corrugated cardboard. Because of the resilient properties, the risk that a permanent indention is created in the surface on the corrugated cardboard is thus reduced.

The above object is further achieved by that the invention relates to a method for producing a corrugated cardboard as presented above and which corrugated cardboard comprises a first flat linerboard pre-treated with a first polymeric coating, a second flat linerboard pre-treated with a second polymeric coating and a corrugated flute arranged between the first and the second linerboard. The method, that does not add to the moisture content of the structure, is performed in a dry process and comprises the steps:
entering the pre-treated first flat linerboard into the method;
entering the flat fluting material to be corrugated in the process
entering the corrugated flute comprising A-peaks on one side and B-peaks on the other side into the method;
joining during influence of a first pressure the pre-treated first flat linerboard and the corrugated flute against each other at a first joining step in the method;
applying a first heat against the corrugated flute which liquefies the first polymeric coating on the pre-treated first flat linerboard;
attaching A-peaks from the corrugated flute against the reactivated polymeric coating arranged on a first inner surface of the first flat linerboard;
solidifying the liquefied first polymeric coating;
transporting the corrugated flute being attached to the first flat linerboard from the first joining step to a second joining step;
entering the pre-treated second flat linerboard into the method;
applying a second heat against the pre-treated second flat linerboard which liquefies the second polymeric coating on the pre-treated second flat linerboard;
joining during influence of a second pressure the pre-treated second flat linerboard and the corrugated flute against each other in the second joining step in the method;
attaching B-peaks from the corrugated flute against the liquified second polymeric coating arranged on a second inner surface of the second flat linerboard;
transporting the corrugated flute being attached between and to the first and second flat linerboard from the second joining step to a cooling step for transferring heat from the corrugated flute and the first and second flat linerboard to a heat receiving element.

An effect of the method is that the corrugated cardboard throughout the process and method for producing the corrugated cardboard is warp-free and may be produced without the corrugated cardboard having to be processed in a drying process for removing or vaporizing liquid because the manufacturing process adds no moisture. The making, manufacture, of the corrugated cardboard according to this text is that the method and the corrugated cardboard has a low sensitivity to the moisture content in the structure. A further effect is that no curing process is needed because the method utilizes linerboards which are pre-treated with polymeric coatings and no moisture is added in the manufacturing process.

According to one embodiment, the first and the second heat have same heating direction with respect to the corrugated flute. An effect of this is that the outer surface of the flat linerboards comprises smoother properties compared to the inner surfaces whereby the outer surfaces don't have to undergo any extra treatment. This may be advantageous for example when the outer surface shall comprise printed text, an image or other subsequent process dependant on the surface roughness or friction.

The applied first and/or second heat may be a welding process where the temperature of the polymeric coating is heated to a range between 80-180 degrees Celsius. In this temperature range, the polymeric coating liquidizes. When liquidizing, the linerboard and corrugated flute material adheres and can be welded together.

According to one embodiment, during the lamination moment between the respective flat linerboard with the corrugated flute, the second flat linerboard is laminated against the corrugated flute with a lower pressure than the pressure applied when laminating the first flat linerboard against the corrugated flute. One effect of this is that a more smooth or flat outer surface is obtained compared to if the respective flat linerboard would be laminated against the corrugated flute with a respective same pressure, or if the second flat linerboard would be laminated against the corrugated flute with a higher pressure. The size of the bellows created on each side of the respective peak during the lamination process determine how smooth or flat the outer surface becomes in the connection between the linerboards and the corrugated flute. A further aspect that effects the surface property to obtain a smooth or flat surface is that the lamination process is performed in a moisture free process.

According to one embodiment, the first heat is applied in the valleys and transported through the corrugated flute. An effect of this is that the process can be made compact as heat can be applied in the tool which directly interacts with the corrugated flute.

According to one embodiment, the first and the second heat may have opposed heating direction during the lamination process.

According to one embodiment, the transporting time between the first joining step and the second joining step is longer than the transporting time between the second joining step and the cooling step. This has the effect that there is no curing process needed after the cooling step. After the cooling step, the corrugated cardboard is ready to be cut or shaped into desired length and size.

According to one embodiment, web length between the first and the second joining step for producing the corrugated cardboard is longer than cooling web length. Web length is length of the corrugated flute and the least one flat linerboard moving between the first and the second joining step. Cooling web length is length of corrugated cardboard entering the cooling step after the second joining step where the polymeric coating holding the corrugated cardboard elements together cures and solidifies. The method and the process to manufacture the corrugated is moisture free. Moisture free means in this context that no moisture or water is actively added to the process for manufacture the corrugated cardboard. If during the manufacture process there would be any moisture or high humidity, for example in the air, it will evaporate during the manufacture process because of the heat present during the manufacture process.

According to one embodiment, the heat from the first and second flat linerboard and the corrugated flute is transferred to the heat receiving element via contact between at least one of the flat linerboards and the heat receiving element. The contact may be friction. This has the effect that the corrugated cardboard may be produced with no subsequent time-consuming curing process. Common in traditional manufacture methods of corrugated cardboard is that subsequent curing may demand several hours, for example up to 12 hours.

According to one embodiment, the transfer of the heat from the first and second flat linerboard with the corrugated flute to the heat receiving element solidifying the polymeric coatings to a dry connection between the first and second flat linerboard with the intermediate corrugated flute. This has the effect that polymeric coatings will go through a phase change from a liquid and hence tacky state to a solid state whereby a firm connection is obtained in the structure between the different layers of the first and second flat linerboard together with the corrugated flute.

### BRIEF DESCRIPTION OF THE DRAWINGS

The invention is described in more detail below with reference to the appended drawings in which:

FIG. 1 is a view of a corrugated cardboard comprising a first and second flat linerboard with a corrugated flute arranged between the first and second flat linerboard.

FIG. 2 is a view of a corrugated flute comprising bending zones with openings.

FIG. 3 is a cross-section view of part of the corrugated flute.

FIG. 4 is a cross-section view of part of the corrugated cardboard.

FIG. 5 is a cross-section view of part of the corrugated cardboard showing first bellows.

FIG. 6 is a cross-section view of part of the corrugated cardboard showing second bellows.

FIG. 7 is a cross-section view of part of an embodiment of the corrugated flute.

FIG. 8 is a cross-section view of part of an embodiment of the corrugated flute having resilient properties.

FIG. 9 is flowchart describing the method steps for producing the corrugated cardboard.

### DETAILED DESCRIPTION OF PREFERRED EMBODIMENT OF THE INVENTION

FIG. 1 illustrates a view a of a corrugated cardboard 1. The corrugated cardboard 1 comprises a first flat linerboard 2, a second flat linerboard 3, and a corrugated flute 4 which is arranged between the first and the second flat linerboard 2, 3. The corrugated flute 4 comprises an A-surface 5a and a B-surface 5b. Between the A-and the B-surface 5a, 5b an internal flute material 6 is present. In the corrugated cardboard 1, the A-surface 5a faces the first flat linerboard 2, and the B-surface 5b faces the second flat linerboard 3. The corrugated flute 4 comprises A-peaks 7a and B-peaks 7b. The A-peaks 7a are arranged on the A-surface 5a and the B-peaks 7b are arranged on the B-surface 5b of the corrugated flute 4. Opposite the A-peaks 7a, on the B-surface 5b of the corrugated flute 4, A-valleys 8a are arranged. Opposite the B-peaks 7b, on the A-surface 5a of the corrugated flute 4, B-valleys 8b are arranged.

FIG. 1 illustrates the first flat linerboard 2 comprises a first inner surface 9a and a first outer surface 10a. The second flat linerboard 3 comprises a second inner surface 9b and a second outer surface 10b. The first flat linerboard 2 is pre-treated with a first coating applied on the first inner surface 9a of the first flat linerboard 2. The second flat linerboard 3 is pre-treated with a second coating on the second inner surface 9b of the second flat linerboard 3. Pre-treated is in this text defined as that the flat linerboards 2, 3 have been treated with a coating before they have entered the production process of the corrugated cardboard 1. The first coating is a first polymeric coating 11a and the second coating is a second polymeric coating 11b.

The second outer surface 10b has smoother properties compared to the first outer surface 10a (not shown in figure). A reason why there is a difference in smoothness properties between the first and second outer surface 10a, 10b is depending on the direction of the heat aimed to reactivate the polymeric coating 11a, 11b. Because of the difference of smoothness between the first and second outer surface 10a, 10b, the second outer surface 10b is preferably used for printing text, applying images or any other subsequent process that benefits from a smoother surface. The first outer surface 10a may because of the mention smoothness differences, for example, be aimed to face towards the interior of a corrugated cardboard box.

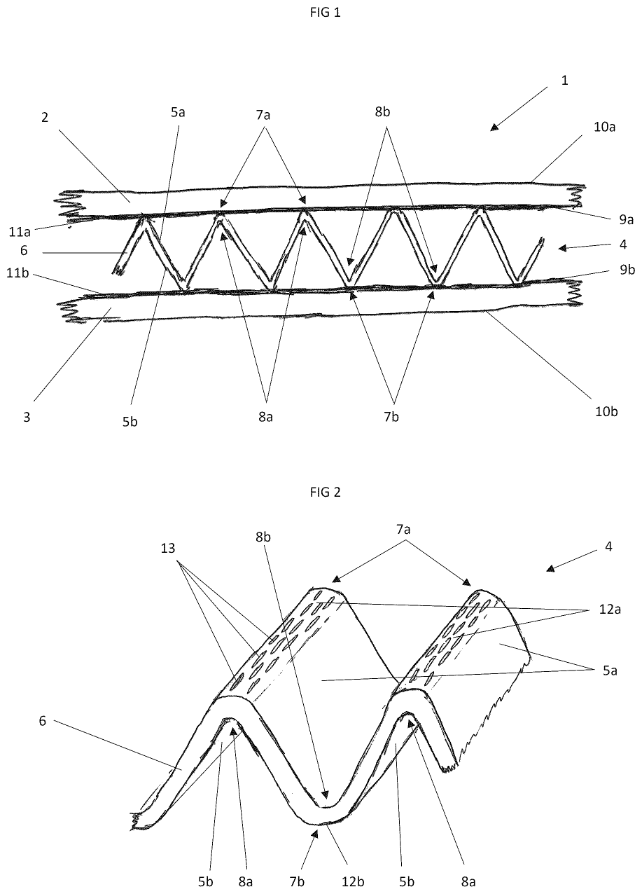

FIG. 2 illustrates a view of the corrugated flute 4. The corrugated flute 4 comprises the A-surface 5a and the opposition arranged B-surface 5b. The corrugated flute 4 comprises the internal flute material 6. On the A-surface 5a the A-peaks 7a are arranged. Opposite the A-peaks 7a, on the B-surface 5b, the A-valleys 8a are arranged. On the B-surface 5b the B-peaks 7b are arranged. Opposite the B-peaks, on the A-surface 5a, the B-valleys 8b are arranged.

FIG. 2 illustrates the A-peaks 7a comprising a first A-bending zone 12a and the B-peaks 7b comprising a first B-bending zone 12b. The A-bending zone 12a and the B-bending zone 12b are arranged with surface openings 13. The surface openings 13 are arranged in the bending zones 12a, 12b for increasing the surface of the corrugated flute 4 utilized for joining against the first and the second flat linerboards 2, 3.

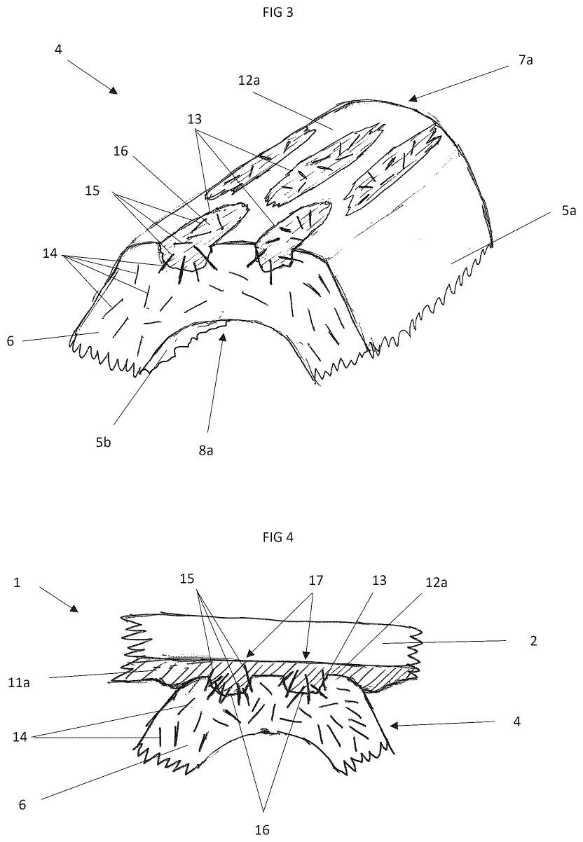

According to one embodiment, the openings 13 may be arranged in the corrugated fluted material 4 before the material has been processed for obtaining its corrugated shape. According to one further embodiment, the openings 13 may be arranged in the corrugated flute 4 upon creating the corrugated shape. According to one embodiment, the surface openings 13 consist of holes arranged in the surface of the bending zone 12a, 12b. According to one embodiment, the surface openings 13 may be created in the surface when the bending zones 12a, 12b are shaped. According to a further embodiment, the surface openings 13 may be surface cracks in the areas of the surface of the bending zones 12a, 12b. According to a further embodiment, the surface opening 13 may be notches in the surface of the bending zones 12a, 12b. The notches or cracks may be preformed in the corrugated flute and in the process when the corrugated flute 4 is formed with peaks 7a, 7b the notches or cracks in the bending zones opens up whereby the internal surface 6 is exposed. The surface openings 13 are openings to the internal flute material 6 of the corrugated flute 4. The surface openings 13 comprises an internal surface 16 (see FIG. 3) which is arranged in the internal flute material 6. An effect of the surface openings 13 with its internal surfaces 16 is that the surfaces of the peaks 7a, 7b when joining against the inner surfaces 9a, 9b of the flat linerboards 2, 3 are increased compared to if the peaks wouldn't have comprised surface openings 13 in its surfaces. The increased surfaces have the further effect that the connection strength between the corrugated flute 4 and the respective flat linerboard 2, 3 is improved.

FIG. 3 illustrates part of the corrugated flute 4 in a cross-section view. In the cross-section view of FIG. 3, the corrugated flute 4 is arranged with the A-surface 5a. The internal flute material 6 is arranged with the A-surface 5a and the B-surface 5b. In FIG. 3 it is shown the A-surface 5a is arranged with the A-peak 7a. The A-peak 7a comprises the first A-bending zone 12a. The A-bending zone 12a, in its surface which is part of the A-surface 5a, is arranged with surface openings 13. The surface openings 13 are spread out over the A-bending zone 12a. The A-bending zone 12a is arranged to join against the first inner surface 9a whereby the surface openings 13 will face towards and be applied against the first inner surface 9a which they will adhere against. The surface openings 13 comprises an internal surface 16. The internal surfaces 16 are arranged inside the openings 13 in the internal flute material 6. The internal flute material 6 comprises fibres 14. Each fibre 14 comprises a respective fibre end 15. In the openings 13, the fibres 14 extend with one fibre end 15 out from the internal surface 16 in the openings 13. The fibres 14 have a mixed direction within the internal flute material 6. The fibre ends 15 extending out or away from the internal surfaces 16 in the respective opening 13 may have a mixed and/or diverged directions depending on its original position and direction in the internal flute material 6. This is due to when the material for the corrugated flute 4 is produced, the fibres 14 are mixed in a slurry which during process becomes the corrugated flute 4.

FIG. 4 illustrates part of the corrugated cardboard 1 in a cross-section view. In the cross-section view of FIG. 4, the first flat linerboard 2 is joined together with the corrugated flute 4 comprising an internal flute material 6 which comprises fibres 14. The first flat linerboard 2 is pre-treated with the first polymeric coating 11a. The corrugated flute 4 is arranged with the first A-bending zone 12a which comprises the openings 13. In the openings 13, the fibre ends 15 are disclosed and extending out from the internal surface 16 of the openings 13. In a joining process between the first flat linerboard 2 and the corrugated flute 4, the first polymeric coating 11a is heated to a liquid phase whereby in the joining process the polymeric coating 11a attaches against the first A-bending zone 12a comprising the surface openings 13. In the joining process, the first polymeric coating 11a enters the openings 13 and merges with the fibres 14 the fibre ends 15 in the surface openings 13 whereby a fibre reinforced connection 17 is created. Because the polymeric coating 11a, 11b is heated to liquid phase, capillary forces, diffusion processes and the force fixing the two surfaces effects the polymeric coating 11a, 11b to be drawn or sucked into the surface openings 13 in connection towards the inner surfaces 9a, 9b. An effect of the fibre reinforced connection 17 is increased strength, rigidity, and stability of the structure of the corrugated cardboard 1. A further effect, because of the capillary force, the amount of polymeric coating is optimized whereby waste from the process because of too much use of coatings, negatively impacting the recycling process, therefore can be avoided.

FIG. 5 illustrates part of the corrugated cardboard 1 in a cross-section view. In the joining or connection process of the first flat linerboard 2 with the A-peaks 7a a first heat is applied in the A-valleys 8a. The first heat is transported through the corrugated flute 4 to the surface of the A-peak 7a. On the first flat linerboard 2, the first heat liquidizes the first polymeric coating 11a which comprises a first coating surface 19a. Simultaneously with the first heat liquidizing the polymeric coating 11a, a first pressure is applied whereby the first flat linerboard 2 and the fluted corrugated cardboard 4 are pressed towards each other. As the first flat linerboard 2 and the fluted corrugated cardboard 4 are pressed towards each other, and because the first heat is transported from the A-peaks 7a towards the first polymeric coating 11a, the first coating surface 19a will form a first bellow 18a on each side of the A-peaks 7a in the connections with the first flat linerboard 2. The polymeric coating being or has become liquidized, or is liquidizing, has the meaning in this text that the polymeric coating has been reactivated to a status, phase, where the polymeric coating first was dry, or substantially dry, and has been reactivated or changed to a tacky or wet phase. In this reactivated phase, status, the polymeric coating may attach or connect to the corrugated flute 4.

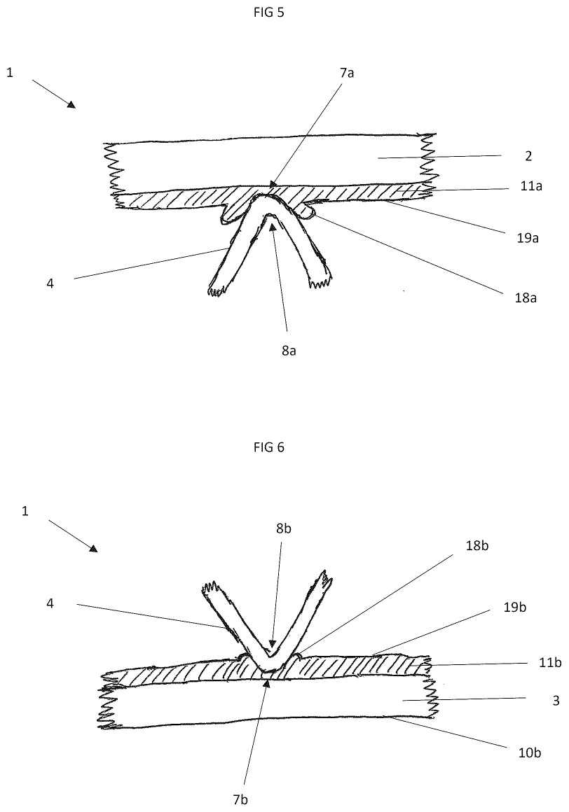

FIG. 6 illustrates part of the corrugated cardboard 1 in a cross-section view. FIG. 5 referred to joining the first flat linerboard 2 with the corrugated flute 4. In FIG. 6 it is illustrated the second flat linerboard 3 being connected with the B-peaks 7b. In the joining process between the second flat linerboard 3 with the B-peaks 7b, a second heat is applied against the second outer surface 10b. The second heat is transported through the second flat linerboard 3 towards the second polymeric coating 11b and further towards a second coating surface 19b of the second polymeric coating 11b. The second heat liquidizes the second polymeric coating 11b such that, towards the second coating surface 19b, the liquidizing is gradually reduced. In this second joining and heat process a second pressure is applied against the first flat linerboard 2 and the second flat linerboard 3 with the fluted corrugated cardboard 4 arranged between. In the second joining process, the B-peaks 7b are pressed towards the liquidized second polymeric coating 11b, the second coating surface 19b forms a second below 18b on each side of the B-peaks in the connection with the second flat linerboard 3.

FIGS. 5 and 6 illustrates the first bellows 18a are larger than then second bellows 18b. This has the effect the outer surface 10a, 10b is smoother than the inner surface 9a, 9b whereby no extra treatment is necessary of the outer surface 10a, 10b, for example during printing.

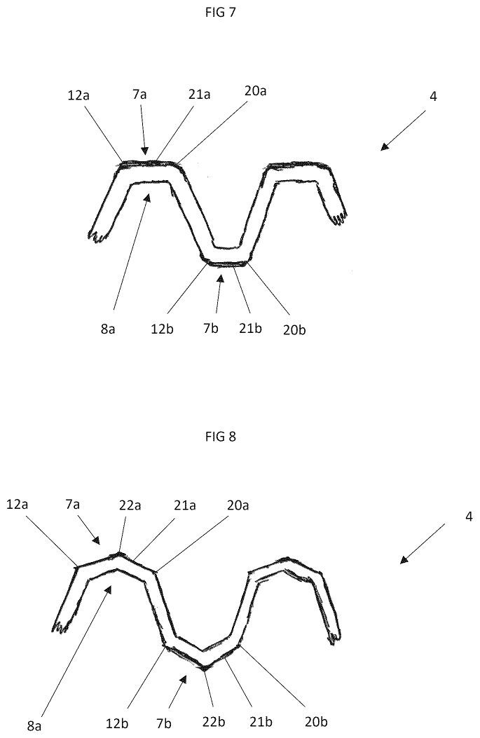

FIG. 7 illustrates part of an embodiment of the corrugated flute 4 where the A-peak 7a comprises a second A-bending zone 20a. The corrugated flute 4 in this embodiment as presented in FIG. 7 is arranged to be connected to a first and second flat linerboard 2, 3 as described above in relation to FIG. 1. The A-peak 7a comprises the first A-bending zone 12a, and the second A-bending zone 20a. Between the two A-bending zones 12a, 20a, a first extension part 21a is arranged. Further, the B-peaks 7b comprises a second B-bending zone 20b. The B-peak 7b comprises the first B-bending zone 12b, and the second B-bending zone 20b. Between the two B-bending zones 12b, 20b, a second extension part 21b is arranged. The first and the second extension part 21a, 21b are parallel with respect to each other. The bending zones 12a, 20a, 12b, 20b are arranged with surface openings 13 (not shown in FIG. 7) as explained above in relation to FIG. 2-4 whereby the respective bending zone 12a, 20a, 12b, 20b has a fibre reinforced connection 17 when connected to the first and the second flat linerboards 2, 3.

FIG. 8 illustrates part of a further embodiment of the corrugated flute 4 where the A peak 7a is arranged with a third A-bending zone 22a. The third A-bending zone 22a is arranged on the first extension part 21a between the first and the second A-bending zones 12a, 20a. Further, the B-peak 7b is arranged with a third B-bending zone 22b. The third B-bending zone 22b is arranged on the second extension part 21b between the first and the second B-bending zones 12b, 20b. In the embodiment of FIG. 8 the first and the second extension part 21a, 21b is V-shaped. The third A-bending zone 22a and the third B-bending zone 22b are arranged with surface openings 13 (not shown in FIG. 8) as explained above in relation to FIG. 2-4. An effect of this is that the respective third bending zone 22a, 22b has a fibre reinforced connection 17 when connected to the first and the second flat linerboards 2, 3. A further effect is that in this embodiment of FIG. 8, the first and second A-bending zones 12a, 20a respective the first and second B-bending zones 12b, 20b may be arranged not being connected to the first and second flat linerboards 2, 3 (not shown in FIG. 8). This allows the corrugated flute 4 to provide a resilient effect of the corrugated cardboard 1 because of the V-shaped structure of the first and second extension part 21a, 21b.

Even though not illustrated in figures, various combinations of the above described A- and B-peaks 7a, 7b in the corrugated flute 4 are possible. One embodiment of a corrugated flute 4 may be a corrugated flute 4 comprising A-peaks 7a as defined in FIG. 1 and B-peaks 7b as defined in FIG. 7. A further embodiment of a corrugated flute 4 may be a corrugated flute 4 comprising A-peaks 7a as defined in in FIG. 1 and B-peaks 7b as defined in FIG. 8. Another embodiment of a corrugated flute 4 may be a corrugated flute 4 comprising A-peaks 7a as defined in FIG. 7 and B-peaks 7b as defined in FIG. 8.

Throughout this text, mentioned A- and B-peaks, A- and B-valleys, A- and B-bending zones, surface openings, polymeric coatings, fibres, fibre ends, internal surfaces, bellows and fibre reinforced connections as defined are not solely related and connected to the figures where they have been mentioned in the text but are also applicable to the figures where they have not been mentioned. This because these features are part of the embodiments of the invention relating to this text.

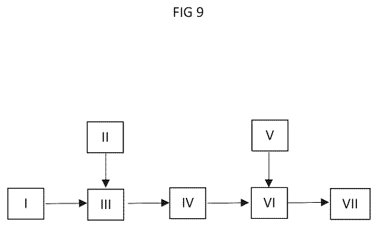

FIG. 9 illustrates a flowchart of a method, process, for producing the corrugated cardboard 1. In the flowchart Greek numbers are used to represent respective step in the method. The corrugated cardboard 1 is manufactured at a manufacture site in a process following the method steps:
I: First flat linerboard 2 is present at the manufacturing site. The first flat linerboard 2 is pre-treated with a first polymeric coating 11a. The first flat linerboard 2 is guided and introduced to method step III.
II: Corrugated flute 4 is made from a base material. The base material is present at the manufacture site. The base material is guided into the process where it is processed by shaping elements to a corrugated flute 4 comprising A-peaks 7a on one side and B-peaks on the other side. The process is continuous whereby the base material is shaped to the corrugated flute 4 and guided and introduced to method step III.
III: The first flat linerboard 2 and the corrugated flute 4 are brought together with presence of a first heat and a first pressure. The first heat comes from a first turning element which is arranged to interact with the corrugated flute 4. The first heat is transported from the first turning element to a first surface of the corrugated flute 4. The first heat is further transported from the A-surface 5a and through the fluted corrugates flute 4 to the opposite arranged B-surface 5b. In this method step III, the B-surface 5b is arranged towards a first inner surface 9a of the first flat linerboard. The first heat having passed through the material 6 of the corrugated flute 4 liquidizes the first polymeric coating 11a arranged on the first flat linerboard 2. Simultaneously as the first polymeric coating 11a liquidizes, a first pressure is applied against a first outer surface 10a of the first flat linerboard 2 and the corrugated flute 4. The connection between the flat linerboard 2 and the corrugated flute 4 is instant and after having been connected the flat linerboard 2 and the corrugated flute 4 are treated as one unit and guided and introduced to method step IV.
IV: The first heat is discontinued whereby there is no active heat applied in the method step IV against the flat linerboard 2 and the corrugated flute 4. The flat linerboard 2 and the corrugated flute 4 are transported as one unit and guided and introduced to method VI.
V: Second flat linerboard 3 is present at the manufacturing site. The first flat linerboard 3 is pre-treated with a second polymeric coating 11b. The second flat linerboard 3 is guided and introduced into method step VI.
VI: The second flat linerboard 3 and the corrugated flute 4 being connected with the first flat linerboard 2 are brought together with presence of a second heat and a second pressure. The second heat comes from a second heat source which is arranged to interact with the first flat linerboard 2. The second heat is transported from the second heat source to a second outer surface 10b of the second flat linerboard 3. The second heat is further transported from second outer surface 10b and through the second flat linerboard 3 to the opposite arranged second inner surface 9b. In this method step VI, the second inner surface 9a is arranged towards a second surface 5b of the corrugated flute 4. The first heat having passed through the material of the second flat linerboard 3 liquidizes the second polymeric coating 11b arranged on the second flat linerboard 3. Simultaneously, the second polymeric coating 11b liquidizes, a first pressure is applied against a first outer surface 10a of the first flat linerboard 2 and the second outer surface 10b of the second flat linerboard 3 whereby the corrugated flute 4 is pressed there between for connecting to the second flat linerboard 3. The now connected first flat linerboard 2, the corrugated flute 4, and the second flat linerboard 3 are now together formed to a corrugated carboard 1 and is guided and introduced to method step VII.
VII: The corrugated cardboard 1 from method step VI obtained and conserved heat which was a result from liquidizing the second polymeric coating 11a. In this method step VII, the corrugated carboard is transported and having friction against a cooling element. During the transport, the heat, in the corrugated cardboard 1, via friction is transported from the corrugated cardboard 1 to the cooling element. After the corrugated cardboard 1 have passed through the cooling element, the corrugated cardboard 1 is ready and can be cut in desired length and sizes for use.

Hereinbefore it has been described that the corrugated cardboard may be related to primarily a corrugated cardboard comprising a first flat linerboard, a second flat linerboard, and corrugated flute. It will be appreciated that the principles described above may be applied to other types corrugated cardboards and methods for producing corrugated cardboards.

### REFERENCE SIGNS

1. corrugated cardboard
2. first flat linerboard
3. second flat linerboard
4. corrugated flute
5a. A-surface
5b. B-surface
6. internal flute material
7a. A-peaks
7b. B-peaks
8a. A-valleys
8b. B-valleys
9a. first inner surface
9b. second inner surface
10a. first outer surface
10b. second outer surface
11a. first polymeric coating
11b. second polymeric coating
12a. first A-bending zone
12b. first B-bending zone
13. surface openings
14. fibres
15. fibre end
16. internal surface
17. fibre reinforced connection
18a. first bellows
18b. second bellows
19a. first coating surface
19b. second coating surface
20a. second A-bending zone
20b. second B-bending zone
21a. first extension part
21b. second extension part
22a. third A-bending zone
22b. third B-bending zone

1-24. (canceled)

25. A corrugated cardboard (1) comprising a first flat pre-treated linerboard (2), a second flat pre-treated linerboard (3), a corrugated flute (4) being arranged between the first and the second flat pre-treated linerboard (2, 3),
wherein the corrugated flute (4) comprises an A-surface (5a), a B-surface (5b), and an internal flute material (6) arranged between the A- and B-surface (5a, 5b),
the corrugated flute (4) comprises A-peaks (7a) and A-valleys (8a) which are arranged opposite each other, B-peaks (7b) and B-valleys (8b) which are arranged opposite each other,
the first flat pre-treated linerboard (2) comprises a first inner surface (9a) and an opposite arranged first outer surface (10a),
the second flat pre-treated linerboard (3) comprises a second inner surface (9b) and an opposite arranged second outer surface (10b),
the first inner surface (9a) is connected against the A-peaks (7a) with a first re-activated adhesive, and
the second inner surface (9b) is connected against the B-peaks (7b) with a second re-activated adhesive,
wherein the first inner surface (9a) is pre-treated with the first re-activated adhesive being a first heat re-activated polymeric coating (11a) coated against the inner surface (9a), the second inner surface (9b) is pre-treated with the second re-activated adhesive being a second heat re-activated polymeric coating (11b) coated against the inner surface (9b),
wherein the polymeric coatings (11a, 11b) on the respective inner surfaces (9a, 9b) have a thickness of 1-10 μm, and the outer surfaces (10a, 10b) are coating free,
the A-peaks (7a) comprise a first A-bending zone (12a) and the B-peaks (7b) comprise a first B-bending zone (12b), such zones comprising fibre dislocations which are surface cracks (13) in the A- and B-surfaces created when the corrugated flute material (6) was corrugated and shaped with the A- and B-peaks (7a, 7b),
the polymeric coatings (11a, 11b) are adhered in a connection between the inner surfaces (9a, 9b) and around the surface cracks (13) and in the surface cracks (13) against the internal flute material (6) of the peaks (7a, 7b), fibre ends (15) extend out and away in divergent and mixed directions from internal surfaces (16) of the surface cracks (13) and are emerged with the polymer coatings (11a, 11b) forming fibre reinforced connections (17) between the peaks (7a, 7b) and the inner surfaces (9a, 9b), and the second outer surface (10b) is smoother than the first outer surface (10a).

26. The corrugated cardboard (1) according to claim 25, wherein the polymeric coatings (11a, 11b) on the respective inner surfaces (9a, 9b) have a surface weight being 0.5-10 g/m² (GSM).

27. The corrugated cardboard (1) according to claim 25, wherein the inner surfaces (9a, 9b) comprise a fibre structure which the polymeric coating (11a, 11b) is bonded to.

28. The corrugated cardboard (1) according to claim 25, wherein the polymeric coating (11a, 11b), being coated against the inner surfaces (9a, 9b), allows for diffusion through the coating (11a, 11b).

29. The corrugated cardboard (1) according to claim 25, wherein at connection between the peaks (7a, 7b) and the inner surfaces (9a, 9b), first and second bellows (18a, 18b) are formed on each side of the peaks (7a, 7b).

30. The corrugated cardboard (1) according to claim 29, wherein the first bellows (18a) arranged on each side of the A-peaks (7a) are larger compared to the second bellows (18b) arranged on each side of the B-peaks (7b).

31. The corrugated cardboard (1) according to claim 25, wherein on the pre-treated inner surfaces (9a, 9b), the first polymeric coating (11a) comprises a first coating surface (19a) which has a smoother surface compared to a second coating surface (19b) which is arranged on the second polymeric coating (11b).

32. The corrugated cardboard (1) according to claim 25, wherein the A-peaks (7a) comprises a second A-bending zone (20a) and that a first extension part (21a) is arranged between the first and the second A-bending zone (12a, 20a), and, the B-peaks (7b) comprises a second B-bending zone (20b) and that a second extension part (21b) is arranged between the first and second B-bending zone (12b, 20b).

33. The corrugated cardboard (1) according to claim 32, wherein the first extension part (21a) between the first and the second A-bending zone (12a, 20a) comprises a third A-bending zone (22a), and the second extension part (21b) between the first and second B-bending zone (12b, 20b) comprises a third B-bending zone (22b).

34. The corrugated cardboard (1) according to claim 32, wherein the first and the second extension parts (21a, 21b) are V-shaped.

35. The corrugated cardboard (1) according to claim 32, wherein the extension part (21a, 21b) being V-shaped is adapted to resiliently move towards and away from the inner surface (9a, 9b) with at least one of the first or second bending zones (12a, 12b, 20a, 20b) while the third bending zone (22a, 22b) is attached to the inner surface (9a, 9b).

36. A method for producing the corrugated cardboard of claim 25 which corrugated cardboard (1) comprises a first flat linerboard (2) pre-treated with a first polymeric coating (11a), a second flat linerboard (3) pre-treated with a second polymeric coating (11b) and a corrugated flute (4) arranged between the first and the second linerboard (2, 3), which method is moisture free and comprises the steps:
entering the pre-treated first flat linerboard (2) into the method;
entering a base material into the method;
processing the base material to the corrugated flute (4) comprising A-peaks (7a) on one side and B-peaks (7b) on the other side into the method;
joining during influence of a first pressure the pre-treated first flat linerboard (2) and the corrugated flute (4) against each other at a first joining step in the method;
applying a first heat against the corrugated flute (4) which liquefies the first polymeric coating (11a) on the pre-treated first flat linerboard (2);
attaching A-peaks (7a) from the corrugated flute (4) against the liquefied first polymeric coating (11a) arranged on a first inner surface (9a) of the first flat linerboard (2);
solidifying the liquefied first polymeric coating (11a);
transporting the corrugated flute (4) being attached to the first flat linerboard (2) from the first joining step to a second joining step;
entering the pre-treated second flat linerboard (3) into the method;
applying a second heat against the pre-treated second flat linerboard (3) which liquefies the second polymeric coating (11b) on the pre-treated second flat linerboard (3);
joining during influence of a second pressure the pre-treated second flat linerboard (3) and the corrugated flute against each other in the second joining step in the method;
attaching B-peaks (7b) from the corrugated flute (4) against the liquified polymeric coating (11b) arranged on a second inner surface (9b) of the second flat linerboard (3);
the first and the second heat have same heating direction with respect to the corrugated flute (4);
transporting the corrugated flute (4) being attached to the first and second flat linerboard (2, 3), from the second joining step to a cooling step for transferring heat from the corrugated flute (4) being attached to the first and second flat linerboard (2, 3), to a heat receiving element.

37. The method according to claim 36, wherein the first heat is applied in the valleys (8a, 8b) and transported through the corrugated flute (4).

38. The method according to claim 36, wherein the transporting time between the first joining step and the second joining step is longer than the transporting time between the second joining step and the cooling step.

39. The method according to claim 36, wherein web length between the first and the second joining step for producing the corrugated cardboard (1) is longer than cooling web length.

40. The method according to claim 36, wherein the heat from the first and second flat linerboard (2, 3) and the corrugated flute (4) is transferred to the heat receiving element via contact between at least one of the flat linerboards (2, 3) and the heat receiving element.

41. The method according to claim 40, wherein the transfer of the heat from the first and second flat linerboard (2, 3) with the corrugated flute (4) to the heat receiving element solidifying the polymeric coatings (11a, 11b) to a dry connection between the first and second flat linerboard with the intermediate corrugated flute (4).
